(19) United States
(12) Patent Application Publication
(10) Pub. No.: US 2005/0247570 A1
(43) Pub. Date: Nov. 10, 2005

(54) Electrochemical method for cleaning the surfaces of metallic work pieces and cleaning electrode

(76) Inventors: Harald Langeder, Pettenbach (AT); Gunter Trettenhahn, Bisamberg (AT)

Correspondence Address: WILLIAM COLLARD;COLLARD & ROE, P.C., 1077 NORTHERN BOULEVARD, ROSLYN, NY, 11576, US

(21) Appl. No.: 10/519,874

(22) PCT Filed: Apr. 16, 2003
(86) PCT No.: PCT/AT03/00112

§ 371 Date: Dec. 30, 2004

(30) Foreign Application Priority Data
Jul. 1, 2002 (AT) A 978/2002

(51) Int. Cl. B23H 3/00

(52) U.S. Cl. 205/666

(57) ABSTRACT

The invention relates to an electrochemical method for the cleaning surfaces of metallic work pieces and an electrode (1) for the electrochemical cleaning of surfaces of metallic work pieces (2), especially surfaces in the region of welded seams. The electrode comprises a connection (4) enabling it to be connected to an electric voltage source (5), and an insulating layer (7) for the impregnation of an electrolyte (8). The aim of the invention is to improve the cleaning effect and to accelerate the cleaning process and to provide maximum protection for an electrode (1). A device (9) for generating an oscillation, especially an ultra sound transmitter, is provided in or on the electrode (1).

The invention relates to an electro-chemical method for cleaning the surfaces of metallic work pieces, in particular the surfaces in the region of welded seams, by using an electrode, wherein an insulating layer is arranged between the electrode and the work piece, and a voltage is applied between the work piece and the electrode and the insulating layer is impregnated with an electrolyte.

The invention further relates to an electrode for electro-chemically cleaning the surfaces of metallic work pieces, in particular the surfaces in the region of welded seams, with a connecting terminal for connection to an electric voltage source and an insulating layer to be impregnated with an electrolyte.

While being processed, metal surfaces often become contaminated which, however, should be avoided both for reasons of corrosion and for aesthetic reasons. Problems are mainly posed by contaminations occurring during the welding of metal construction parts on account of the heat occurring during the welding procedure. These are oxide layers, slags or other welding residues which cannot be completely prevented even in welding procedures under a protective gas atmosphere.

To remove such contaminations, the work pieces often are cleaned in a separate working step which may be by mechanical action, chemical methods or electro-chemical methods. Purely mechanical cleaning methods often are very complex and lead to undesired scratches also on those surfaces which had not been contaminated. However, such scratched surface areas in turn are characterized by being increasingly susceptible to corrosion, frequently requiring a further after-treatment. Gentler, yet not as effective, are chemical methods (e.g. pickling), in which the contaminations are removed with certain solvents.

Optimum cleaning results, particularly in case of contaminations which occur after the welding processes on the metal surfaces, have been obtained by electro-chemical cleaning methods in which the contaminations can be quickly and gently removed by forming an electro-chemical cell or an electrolysis cell with simultaneous mechanical action. In doing so, the work piece to be cleaned is connected to the pole of a voltage source while the electrode (cleaning electrode) is connected to the other pole of the voltage source. The electrode is provided with an insulating layer so that a short circuit between the work piece and the electrode can be produced. To form an electro-chemical cell or an electrolysis cell, the insulating layer which, as a rule, consists of a fabric, e.g. a fiberglass fabric, is impregnated with a liquid electrolyte. By the action of the electrolyte and the electric current, the surface of the work piece is galvanically cleaned in the region between the electrode and the work piece surface located therebelow. The electrolyte may be manually applied to the insulating layer of the electrode, or it may be continuously guided to the electrode by a respective feed line.

DE 200 19 118 U1 describes an apparatus for the localized cleaning of metal surfaces, particularly in the region of welded seams, comprising a cell of a corrosion-resistant material, by which a spent pickling acid is held back in the working position. To improve the cleaning effect, pickling acid present in the interior of this cell is set into vibrations. For this purpose, a generator for ultrasonic waves is put onto the end of the sonotrode. Apart from the fact that the use of such acids for pickling the metal surface requires special precautions, also the construction of the cleaning device is particularly laborious and complicated. Moreover, sealing relative to the surface to be cleaned often is difficult, or not possible, respectively, because of the roughness of the surface.

A device for electro-chemically cleaning metal surfaces of this type is described, e.g., in DE 298 23 753 U1. There, a combination of a micro-abrasive treatment and an electro-chemical treatment is described for as effective a removal of contaminations as possible, which simultaneously is gentle on adjacent, non-contaminated areas.

Another device for purifying metals after their processing with high temperatures is known from WO 97/12081 A1, where the insulating layer which surrounds the end of the electrode consists of polyether ehter ketone, so that burning of the insulating layer by undesired high currents between the electrode and the work piece is avoided.

U.S. Pat. No. 6,315,885 B1shows a further method for electro-chemically cleaning work pieces, in which the electorlyte used is set into vibrations in the ultrasonic range and, thus, the cleaning effect is improved. There, cleaning is carried out in a cleaning container by immersing the work piece in the electrolyte. This method is particularly complex and not suitable for big work pieces, such as, e.g., parts of car bodies.

Furthermore, DE 33 43 396 A1describes a method for decontaminating metallic components of a nuclear-technical plant, wherein an electrolyte-liquid filled trough-shaped electrode is moved along the component to be cleaned. The invention is based on the object of producing as low amounts as possible of waste to be removed which is achieved by guiding the electrolyte in circulation via a filter. No details are given regarding the actual design of the electrode, except for the enclosing of a sponge body filled with the electrolyte liquid.

Moreover, the known electrochemical cleaning methods all share the disadvantage that the duration of the cleaning procedure for an optimum cleaning effect is relatively long.

The present invention therefore has as its object to provide an electro-chemical cleaning method as set out above, by which an improved cleaning effect, on the one hand, and an acceleration of the cleaning procedure, on the other hand is obtained, while at the same time the wear of the electrode is as slight as possible.

A further object of the invention consists in providing an initially defined electrode for electro-chemically cleaning metal surfaces, with which an improved cleaning effect with a simultaneous acceleration of the cleaning procedure and as low a wear of the electrode as possible can be obtained.

Disadvantages of known cleaning processes, or of cleaning electrodes, respectively, are to be avoided, or at least reduced, respectively.

With a view to process technology, the object according to the invention is achieved in that during the cleaning procedure, the electrode is set into vibrations with frequencies preferably in the ultrasonic range. By the vibration-caused mechanical effect on the electrode, or the transmission of the vibration from the electrode to the electrolyte and, thus, to the metal surface, a substantial acceleration of the cleaning procedure and an improvement in the cleaning effect are attained. By the electrolyte-provided insulating layer being arranged between the electrode and the surface of the work piece, there is no direct mechanical action of the electrode surface on the metal surface and, thus, no undesired damaging of the metal surface.

If the electrode is set into vibrations in the frequency range of more than 20 kHz, preferably between 100 kHz and 2 MHz, optimum results can be achieved while at the same time the expenditures for producing the vibrations are kept low.

Advantages can, moreover, be obtained in that the vibration amplitude can be changed. Thus, by changing the vibration amplitude, e.g. by changing the supply voltage of an electromagnetic or piezo-electric vibration generator, the cleaning effect can be manually or automatically adapted to the respective conditions, such as, e.g., the degree of contamination.

The object according to the invention is also achieved by an electrode for electro-chemically cleaning surfaces of metallic work pieces, in particular surfaces in the region of welded seams, with a terminal for connection to an electric voltage source and an insulating layer to be impregnated with an electrolyte, in which a means of generating a vibration is provided. By this vibration generating means, the cleaning effect is substantially improved and an acceleration of the cleaning procedure is achieved without increasing the wear of the electrode.

The vibration generating means preferably is formed by an ultrasonics generator. Such vibration generating means are comparatively cost-effective and robust. Moreover, with ultrasonics generators such as, e.g., piezo crystals, an optimum result can be provided.

The vibration generating means may be arranged directly within the electrode, it may form part of the electrode, or it may be externally fastened to the electrode. The last-mentioned embodiment is particularly well suited for retrofitting of existing electrodes.

According to a further feature of the invention, a handle is provided which is mounted in a vibration-damping manner or which is provided with a vibration-damping layer. In this way, comfortable handling of the cleaning electrode is attainable, since the vibrations emanating from the vibration generating means are not transmitted to the hand of the operator or only a very slight part thereof is transmitted, respectively. Various elastic materials, in particular plastics with an energy-absorbing effect, may be used.

In addition to the present insulating layer, a layer of an elastic material may be provided which prevents the direct contact between the electrode surface and the work piece, and thus is gentle on the electrode and also on the work piece surface.

If a layer of carbon is provided, the voltage losses and the wear of the electrode can be minimized. By this, an increased performance for the cleaning process proper is achieved. Instead of a carbon coating, also other coatings of special materials may be provided on the electrode, whereby the wear of the electrode can be reduced.

The insulating layer to be impregnated with the electrolyte preferably is made of a fabric, such as, e.g., fiberglass fabric. The insulating layer must be porous so that an absorption of a liquid or pasty electrolyte is possible.

Alternatively, the insulating layer may also be formed by nodules or the like made of plastics, by which the electrode surface is kept at a safe and defined distance from the work piece surface and between which a space for introducing a liquid or pasty electrolyte for forming an electro-chemical cell remains clear. The nodules or the like made of plastics may be glued to the electrode surface or applied to the electrode surface e.g. via a carrier fabric.

Preferably, a feed line for delivering the electrolyte is provided so that electrolyte can be delivered to the electrode continuously and, thus, the cleaning process can be carried out without interruptions.

The feed line may also include a means for metering the electrolyte, so that an automatic or manual adaptation of the supplied electrolyte amount to the respective conditions, such as, e.g., the degree of contamination, can be effected.

Moreover, at least one further line may be provided for delivering additional components to the electrolyte. However, such mixing of the electrolyte with additional components may also occur before the former is delivered, so that only one line will be required for delivery of the electrolyte.

The present invention will now be explained in more detail by way of the accompanying drawings which show different exemplary embodiments of the invention.

Therein:

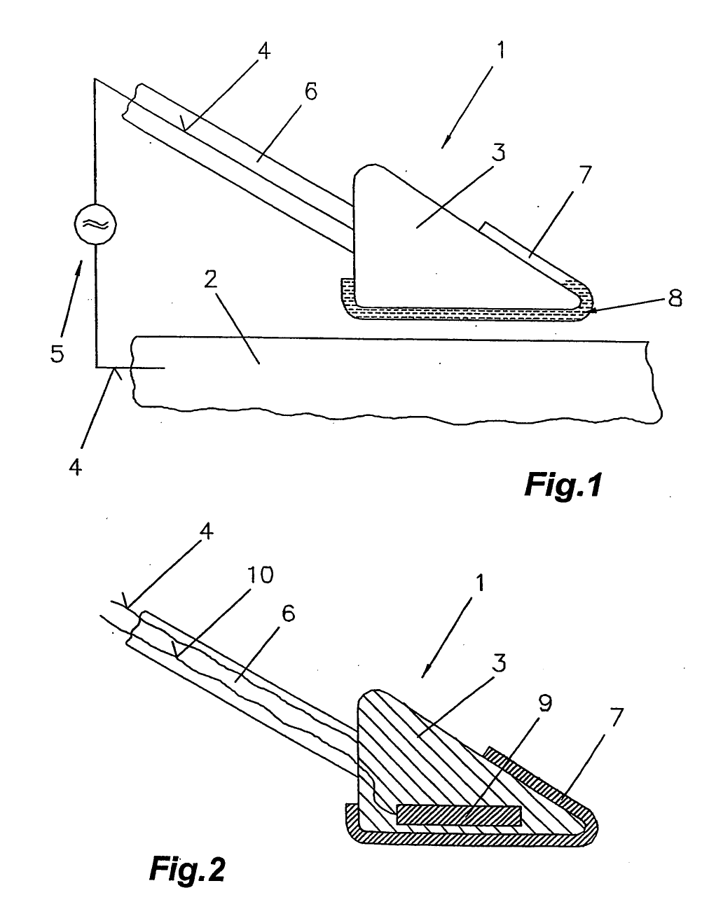

FIG. 1 shows a sketch of the principle of an electrode for electro-chemically cleaning surfaces of metallic work pieces;

FIG. 2 shows a cross-section through an electrode for electro-chemically cleaning surfaces of metallic work pieces according to one embodiment of the invention;

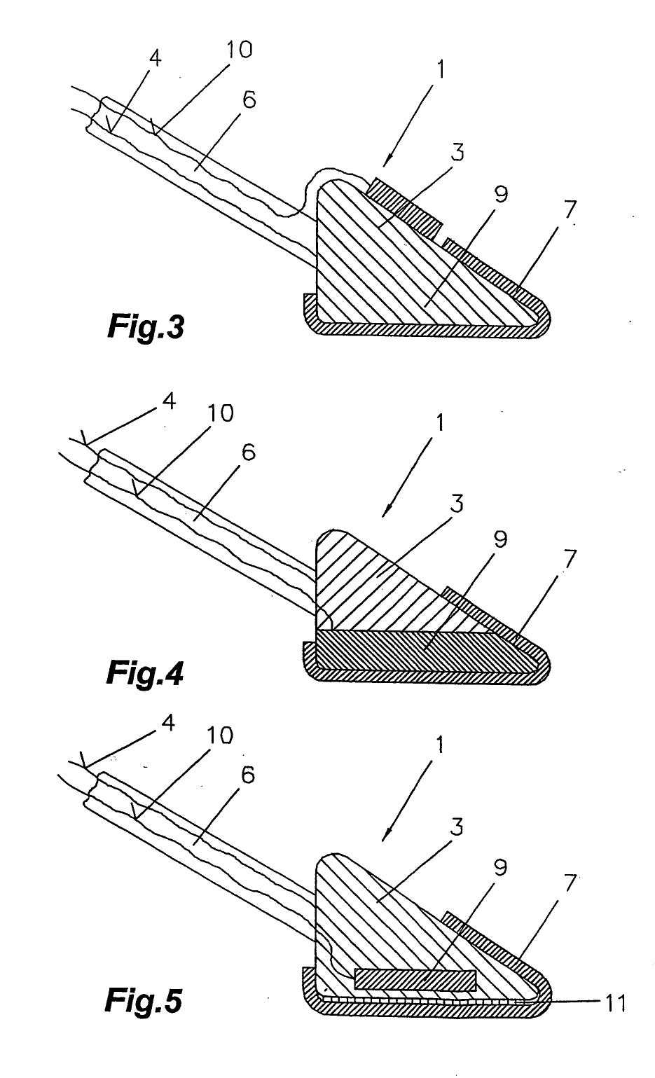

FIGS. 3 to 5 show further embodiments of the invention;

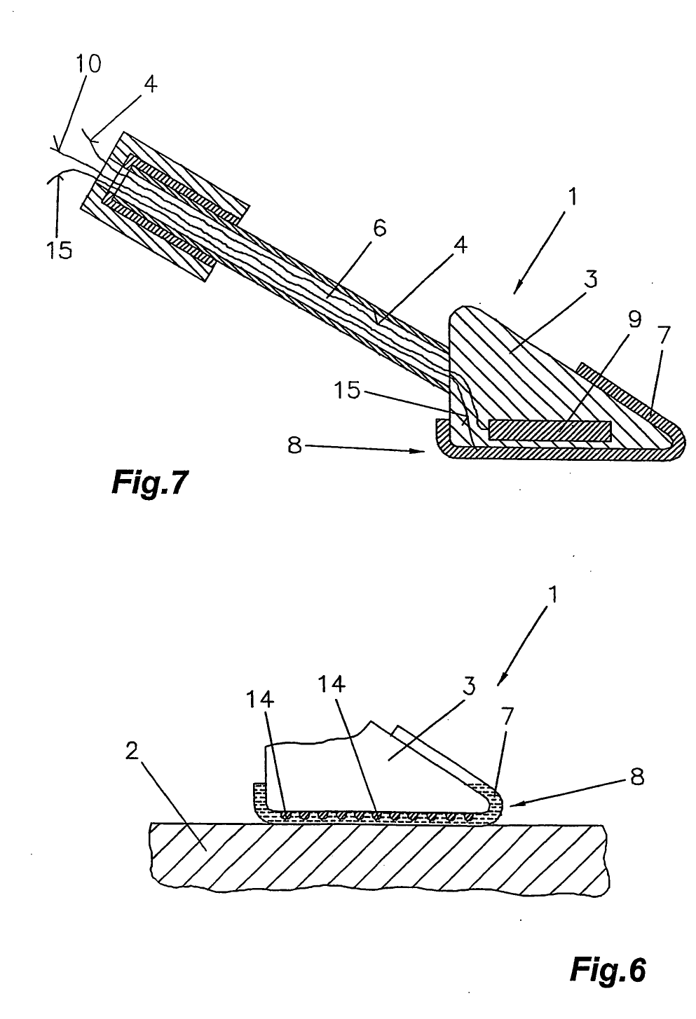

FIG. 6 shows a detail of an electrode with an insulating layer in the form of plastics nodules, which electrode rests on a work piece; and

FIG. 7 shows a schematic cross-sectional view of a cleaning electrode provided with a handle.

FIG. 1 shows a sketch of a principle of an electrode 1 for electro-chemically cleaning surfaces of metallic work pieces 2. Between the work piece 2 and the metallic electrode body 3, a voltage source 5 is connected via appropriate lines 4. The line 4 starting from the electrode body 4 may be arranged within a connecting piece 6 for connecting the electrode body 3 with a handle. The electrode body 3 of the electrode 1 is at least partially enveloped by an insulating layer 7. By this insulating layer 7, which may, e.g., be formed by a fiberglass fabric, a short-circuit between the electrode body 3 and the surface of the metallic work piece 2 will be prevented. To form an electrochemical cell, the insulating layer 7 is impregnated with a suitable electrolyte 8, e.g. a polyphosphoric acid solution. Subsequently, the electrode 1 is placed upon the work piece 2 at the contaminated sites thereof and moved. The contaminations are electro-chemically removed, and the surface of the work piece 2 is largely spared. Such a cleaning procedure, however, is relatively long due to a frequent repeating of the cleaning procedure and the impregnating of the insulating layer 7 in the electrolyte 8.

FIG. 2 shows one embodiment of an electrode 1 according to the invention in cross-section. Within the electrode body 3, a means 9 for generating a vibration, e.g. an ultrasonics generating means, is installed. The vibration generating means 9 is supplied with electric energy via appropriate connecting cables 10. The connecting cables 10 as well as the connecting line 4 for a connection to an electric voltage source in the respective connecting piece 6 may be provided to extend to a possibly present handle. By the vibration generating means 9, the electrode 1 is set into vibration, in particular an ultrasonic vibration, which accelerates and assists in the cleaning procedure.

According to FIG. 3, the vibration generating means 9 may also be arranged on the electrode body 3 of the electrode 1, thereby enabling retrofitting of existing cleaning electrodes 1, e.g.

FIG. 4 shows a further embodiment of an electrode 1, in which a part of the electrode body 3 is formed by the vibration generating means 9.

In the variant embodiment according to FIG. 5, a layer 11 is arranged between the electrode body 3 of the electrode 1 and the insulating layer 7, which layer 11 may, e.g., consist of an elastic material and protects the surface of the electrode 1 as well as the surface of the work piece 2 against direct effects of the vibration generating means 9, e.g., if the insulating layer 7 is damaged.

FIG. 7 shows an electrode 1 which is connected to a handle 12 via a connecting piece 6. To prevent vibrations emanating from the vibration generating means 9 from being transmitted to the handle 12, the handle 12 is mounted in a vibration-dampening manner by a vibration-damping layer 13 being arranged between the handle 12 and the connecting piece 6. At the rear end of the handle 12, the connecting lines 4, 10 for the electrode body 3 and the vibration generating means 9 emerge. Likewise, a duct 15 for delivering the electrolyte 8 to the insulating layer 7 may be arranged passing through the handle 12, the connecting piece 6, and the electrode body 3.

The detail according to FIG. 6 shows a part of the surface of the electrode body 3 and the surface of the work piece 2. In this variant embodiment, the insulating layer 7 is formed of nodules 14 or the like of plastics, between which nodules the electrolyte can be accommodated. This is an alternative embodiment of the insulating layer 7, like the fabric layers frequently used.

The present invention is not restricted to the illustrated embodiments of the electrodes 1. In particular, various means 9 for generating a vibration may be arranged in the electrode 1 or placed thereon.

1. An electro-chemical method for cleaning the surfaces of metallic work pieces, in particular the surfaces in the region of welded seams, by using an electrode, wherein an insulating layer is arranged between the electrode and the work piece, and a voltage is applied between the work piece and the electrode and the insulating layer is impregnated with an electrolyte, wherein during the cleaning procedure, the electrode is set into vibrations with frequencies preferably in the ultrasonic range.

2. A cleaning method according to claim 1, wherein the electrode is set into vibrations in the frequency range of more than 20 kHz, preferably between 100 kHz and 2 MHz.

3. A cleaning method according to claim 1, wherein the vibration amplitude is changed.

4. An electrode (1) for electro-chemically cleaning the surfaces of metallic work pieces (2), in particular the surfaces in the region of welded seams, with a connecting terminal (4) for connection to an electric voltage source (5) and an insulating layer (7) to be impregnated with an electrolyte (8), wherein a means (9) for generating a vibration is provided.

5. A cleaning electrode according to claim 4, wherein the vibration generating means (9) is formed by an ultrasonics generator.

6. A cleaning electrode according to claim 4, wherein the vibration generating means (9) is arranged in the electrode (1).

7. A cleaning electrode according to claim 4, wherein the vibration generating means (9) forms part of the electrode (1).

8. A cleaning electrode according to claim 4, wherein the vibration generating means (9) is fastened to the electrode (1).

9. A cleaning electrode according to claim 4, wherein a handle (12) is provided which is mounted in a vibration-damping manner or which is provided with a vibration-damping layer (13).

10. A cleaning electrode according to claim 4, wherein a layer (11) of elastic material is provided.

11. A cleaning electrode according to claim 4, wherein a layer of carbon is provided.

12. A cleaning electrode according to claim 4, wherein the insulating layer (7) is formed of a fabric, preferably a fiberglass fabric.

13. A cleaning electrode according to claim 4, wherein the insulating layer (7) is formed of nodules (14) or the like of plastics.

14. A cleaning electrode according to claim 4, wherein a line (15) for delivering the electrolyte (8) is provided.

15. A cleaning electrode according to claim 10, wherein the feed line (15) contains a means for metering the electrolyte (8).

16. A cleaning electrode according to claim 10, wherein a line for delivering additional components to the electrolyte (8) is provided.
